(19) United States
(12) Patent Application Publication
(10) Pub. No.: US 2010/0170636 A1
(43) Pub. Date: Jul. 8, 2010

(54) SEMI-INTERPENETRATING NETWORK HAVING A PHASE OF A LINEAR NONCROSSLINKED ISOBUTENE POLYMER

(75) Inventors: Phillip Hanefeld, Heidelberg (DE); Nicole Hildebrandt, Mannheim (DE); Klaus Muehlbach, Gruenstadt (DE); Helmut Mach, Heidelberg (DE); Hans-Michael Walter, Freinsheim (DE); Dominique Teyssie, Le Pecq (FR); Odile Fichet, Poissy (FR); Cedric Vancaeyzeele, Vernauillet (FR); Benjamin Davion, Cergy (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/664,527

(22) PCT Filed: Jun. 19, 2008
(86) PCT No.: PCT/EP08/57815

§ 371 Date: Dec. 14, 2009

(30) Foreign Application Priority Data
Jun. 19, 2007 (EP) 07110606.6
Nov. 7, 2007 (EP) 07120214.7

(51) Int. Cl. C08L 23/00; C08L 25/02; C08L 83/04; C08L 75/04; C08L 75/02; B32B 37/12; B05D 3/02; B05D 3/06

(52) U.S. Cl. 156/275.5; 525/55; 525/191; 525/241; 525/232; 525/105; 525/123; 156/334; 427/385.5; 427/496

(57) ABSTRACT

A description is given of a semi-interpenetrating network having a first phase of a linear noncrosslinked isobutene polymer and a second phase of a crosslinked polymer, wherein the crosslinked polymer is obtained by crosslinking molecular enlargement reaction in the presence of the isobutene polymer. The crosslinked polymer is preferably obtained by free-radical polymerization of ethylenically unsaturated monomers comprising at least one polyethylenically unsaturated monomer. The networks are suitable as molding compounds having gas and moisture barrier effect or as adhesives.

The invention relates to a semi-interpenetrating network having a first phase of a linear noncrosslinked isobutene polymer and a second phase of a crosslinked polymer.

Linear polyisobutenes are notable for particular properties, such as high gas and moisture barrier effect and high tackifying effect. The gas and moisture barrier effect of the polyisobutenes is exploited, for example, in sealants. Disadvantages exhibited by linear polyisobutenes include a high creep tendency and cold flow, which for many applications are undesirable. Although the creep tendency can be reduced by admixing fillers, such as carbon black or talc, these mixtures are nevertheless not completely satisfactory.

The tackifying effect of the polyisobutenes is exploited in adhesives. Owing to the low level of cohesion of the polyisobutenes, however, the adhesives are not completely satisfactory.

From, for example, Paul D. R. and Barlow J. W., J. Macromol. Sci., Rev. Macromol. Chem., 18, 109 (1980) and Krause S. in “Polymer Blends” 1, 66, Paul D. R. and Newman S. (eds.), Academic Press New York (1978), it is known that polyalkylene polymers and atactic polystyrene are entirely incompatible. Physical mixtures of these polymers are heterogeneous and, because of the poor miscibility, have the two glass transition temperatures of the pure components.

Attempts have been made to mix the polymers at a molecular level and so to obtain what are called interpenetrating networks, by swelling a crosslinked polyalkylene polymer with styrene and then polymerizing the styrene in situ. The degree of swelling achievable, however, is restricted, and it is not possible in this way to introduce any polystyrene fractions substantially higher than 10% into the network. Moreover, the associated modification of properties is unstable and disappears on thermal exposure, owing to separation phenomena.

DE 31 15 368 describes the preparation of a high-impact polystyrene. An isobutene polymer is dissolved in styrene, a peroxide is added, and polymerization is carried out.

WO 2005/019285 describes a molding compound which comprises an interpenetrating mixture of a crosslinked isobutene polymer and a stiffening polymer with (meth)acrylic and/or vinylaromatic units. The crosslinked isobutene polymer is the reaction product of an isobutene polymer having on average at least 1.4 functional groups in the molecule and a crosslinking agent having an average of at least two functional groups in the molecule which have complementary functionality with respect to the functional groups of the isobutene polymer.

U.S. Pat. No. 5,270,091 describes a sealing strip which serves as a spacer between the glass panes of an insulated glass window. The strip comprises a deformable sealing material which is obtained by mixing unfunctionalized polyisobutene with butyl rubber and then crosslinking the butyl rubber. The subsequent crosslinking of the butyl rubber, however, is difficult to control, and homogeneous crosslinking and/or sufficiently high crosslinking densities can be achieved only with difficulty, if at all. The aftercrosslinking may also be accompanied by unwanted side reactions and depolymerization of the polyisobutene. Overall, the resulting polymer network is poorly defined.

U.S. Pat. No. 4,477,325 discloses a wound dressing which comprises a mixture of an ethylene-vinyl acetate copolymer and polyisobutene. After shaping, the mixture is treated with y rays in order to crosslink the ethylene-vinyl acetate copolymer. The y radiation crosslinking is difficult to control, and homogeneous crosslinking and/or sufficiently high crosslinking densities can be achieved only with difficulty, if at all. Unwanted side reactions and depolymerization of the polyisobutene are unavoidable.

It is desirable to have available (1) dimensionally stable sealants and moldings, respectively, with high gas and moisture barrier effect, and (2) adhesives which combine high adhesion with high cohesion.

The object is achieved in accordance with the invention by means of a semi-interpenetrating network having a first phase of a linear noncrosslinked isobutene polymer and a second phase of a crosslinked polymer, wherein the crosslinked polymer is obtained by crosslinking molecular enlargement reaction in the presence of the isobutene polymer.

A semi-interpenetrating network is a combination of a crosslinked polymer and a linear noncrosslinked polymer where one polymer is synthesized in the presence of the other. Between the two polymer constituents there are substantially no covalent bonds. The noncrosslinked polymer penetrates the network of the crosslinked polymer and has the effect that, as a result of interengagements in the form of hooks and loops, the two components are virtually impossible to separate physically. This semi-interpenetrating network permits the combination of properties of two polymers, in spite of their thermodynamic incompatibility. As compared with common polymer blends, the semi-interpenetrating networks are more resistant to separation and have better mechanical properties. The degradation resistance of the semi-interpenetrating networks is commonly better than that of copolymers in which the incompatible polymers have been bonded to one another covalently in the form of blocks.

In the present invention an isobutene polymer is used as the linear uncrosslinked polymer. The semi-interpenetrating network allows the production of (1) materials which feature high gas and moisture barrier effect without tack and without cold flow, or (2) materials which feature tack and very low cold flow, or (3) materials which feature high gas and moisture barrier effect and tack without cold flow.

The weight ratio of the first to the second phase in the molding compound of the invention is generally 5:95 to 95:5, preferably 5:95 to 80:20, more particularly 30:70 to 70:30.

Compositions with high levels of the crosslinked polymer (e.g., with a weight ratio of the first phase to the second phase of 60:40 to 10:90, preferably 50:50 to 30:70) display substantially no tack and no cold flow. The gas and moisture barrier effect of the polyisobutene is maintained. The compositions are suitable as dimensionally stable sealants or moldings with barrier effect for air and/or water vapor.

In the case of inventive compositions with a high isobutene polymer fraction (e.g., with a weight ratio of the first to the second phase of 60:40 to 90:10, preferably 60:40 to 80:20), the tackifying properties of the polyisobutene are largely retained. The compositions, however, are largely free from cold flow and exhibit improved cohesion as compared with polyisobutene.

By varying the weight ratio of the first to the second phase and/or the degree of crosslinking of the second phase it is possible to tailor the properties of the semi-interpenetrating network to the particular requirements. Thus, for example, watertight adhesives or tacky sealants can be obtained.

Through the presence of the crosslinked second phase it is also possible for moldings to be produced with a high isobutene polymer fraction.

Isobutene polymer

The isobutene polymer comprises at least 80%, more particularly at least 90%, and with particular preference at least 95%, and most preferably at least 99%, by weight of isobutene units. Besides isobutene units the isobutene polymer may also comprise units of olefinically unsaturated monomers which are copolymerizable with isobutene. The comonomers may be distributed randomly in the polymer or may be arranged in the form of blocks. Suitable copolymerizable monomers include, in particular, vinylaromatics such as styrene, C₁-C₄ alkylstyrenes such as α-methylstyrene, 3- and 4-methylstyrene or 4-tert-butylstyrene, and also isoolefins having 5 to 10 C atoms, such as 2-methylbut-1-ene, 2-methylpent-1-ene, 2-methylhex-1-ene, 2-ethylpent-1-ene, 2-ethylhex-1-ene, and 2-propylhept-1-ene, or dienes such as isoprene or butadiene.

The isobutene polymer preferably has a number-average molecular weight of 500 to 500 000, more particularly 1000 to 200 000, with particular preference 20 000 to 100 000.

Inventively suitable polyisobutenes and their preparation are described, for example, in U.S. Pat. No. 5,137,980, EP-A-145235, and U.S. Pat. No. 5,068,490. They are obtained generally by cationic polymerization of isobutene. The polymerization takes place with, for example, boron trifluoride catalysis.

Suitable polyisobutenes are available under the name Oppanol® B 10, Oppanol® B 12 or Oppanol® B 15 from BASF Aktiengesellschaft, Ludwigshafen, Germany.

In general, on the basis of its preparation by cationic polymerization, the polyisobutene has an ethylenic unsaturation at one end of the molecule. This ethylenic unsaturation is generally not homopolymerizable or copolymerizable by free-radical polymerization. On free-radical polymerization of ethylenically unsaturated monomers in the presence of the isobutene polymer, therefore, the isobutene polymer plays substantially no part in the reaction. No covalent bonds are formed between the resultant crosslinked polymer and the isobutene polymer. The isobutene polymer has preferably no functional groups (apart from an optional terminal ethylenic unsaturation).

Crosslinked Polymer

The second phase of the semi-interpenetrating network of the invention is formed by a crosslinked polymer. The crosslinked polymer is obtained by crosslinking molecular enlargement reaction in the presence of the isobutene polymer. A crosslinking molecular enlargement reaction is a reaction in which, parallel with the enlargement of a macromolecule from monomeric and/or oligomeric constituents, branches and/or crosslinks are incorporated into the growing polymer chains.

An example of a procedure for preparing the semi-interpenetrating network of the invention is to subject monomers which construct the crosslinked polymer to a molecular enlargement reaction together with at least one crosslinking agent in the presence of the isobutene polymer. An alternative is to subject polyfunctional resin precursors, such as phenolic resin precondensates, to a molecular enlargement reaction in the presence of the isobutene polymer.

The nature of the molecular enlargement reaction is not critical. It may, for example, be an addition polymerization of ethylenically unsaturated monomers, which may be catalyzed free-radically, anionically or cationically, or else a polyaddition or a polycondensation.

The construction and the chemical nature of the crosslinked polymer are not critical provided it can be prepared from precursors which are at least partly miscible with the isobutene polymer and that the molecular enlargement reaction can be carried out under conditions, in respect more particularly of the temperatures employed, nature of the catalysts and the like that are used, which do not lead to any substantial impairment and/or decomposition of the isobutene polymer.

In one embodiment the crosslinked polymer is obtained by free-radical polymerization of ethylenically unsaturated monomers comprising at least one polyethylenically unsaturated monomer.

In another embodiment the crosslinked polymer is a polysiloxane.

In another embodiment the crosslinked polymer is a polyurethane and/or polyurea. This enumeration is not conclusive.

In another embodiment the crosslinked polymer is a resole resin. Crosslinked polymer obtained by free-radical polymerization

Suitable ethylenically unsaturated monomers include the following:

vinylaromatic monomers, such as styrene, ring-alkylated styrenes with preferably C₁-C₄ alkyl radicals, such as a-methylstyrene, p-methylstyrene;

(meth)acrylic monomers, such as alkyl acrylates and methacrylates having 1 to 18 C atoms in the alkyl radical, such as more particularly methyl methacrylate, ethyl methacrylate, propyl (meth)acrylate, isopropyl (meth)acrylate, n-butyl (meth)acrylate, isobutyl (meth)acrylate, tert-butyl (meth)acrylate, hexyl (meth)acrylate, cyclohexyl (meth)acrylate, decyl (meth)acrylate, isodecyl (meth)acrylate, lauryl (meth)acrylate, isobornyl (meth)acrylate, and adamantyl (meth)acrylate;

benzyl (meth)acrylate, phenyl (meth)acrylate, tert-butylphenyl (meth)acrylate, 4-biphenyl (meth)acrylate, and 2-naphthyl (meth)acrylate;

acrylonitrile, methacrylonitrile,

or mixtures of said monomers. This enumeration is not conclusive.

Styrene, cyclohexyl methacrylate, and C3-C18 alkyl methacrylates are particularly suitable monomers.

It is also possible to use a small fraction, up to 2% by weight for example, based on the total amount of the monomers, of water-soluble or hydrophilic monomers. Water-soluble monomers are, for example, (meth)acrylic acid, (meth)acrylamide. Hydrophilic monomers are in particular those which possess a hydroxyl and/or amino group, such as 2-hydroxyethyl (meth)acrylate, 2-hydroxypropyl (meth)acrylate, butanediol mono(meth)acrylate, and dimethylaminoethyl (meth)acrylates.

Further suitable monomers can be taken, for example, from the Handbook of Polymers, CRC Series.

It is preferred to use monomers and monomer mixtures which produce a polymer or copolymer, respectively, having a glass transition temperature of more than −70° C., preferably more than +20° C., and more preferably more than +50° C.

Preference is given to using monomers and monomer mixtures which produce a polymer or copolymer, respectively, having a solubility parameter which differs from that of the isobutene polymer by less than 1 MPa^{1/2}, preferably less than 0.7 MPa^{1/2}, more particularly less than 0.5 MPa^{1/2}. With a small difference between the solubility parameters of the isobutene polymer and of the crosslinked polymer, the mutual compatibility of the polymers is high and the extractable fraction of the network is low. From this standpoint, styrene (polyisobutene/polystyrene solubility parameter difference=0.31 MPa^{1/2}) and cyclohexyl methacrylate (polycyclohexyl methacrylate/polystyrene solubility parameter difference=0.20 MPa^{1./2}) are particularly preferred.

The calculation method (incremental method of Hoftyzer-van Krevelen) and experimentally determined values for the solubility parameters are elucidated in U.S. Pat. No. 6,362,274 B1, J. Applied Polym. Sci. 2000, 78, 639, and in the following monograph: D. W. van Krevelen, “Properties of polymers. Their correlation with chemical structure; their numerical estimation and prediction from additive group contributions”, 3rd edition, Elsevier, 1990, pp. 189-225.

By selecting monomers with a similar refractive index to that of the isobutene polymer it is possible to prepare transparent semi-interpenetrating networks. Accordingly, transparent semi-interpenetrating networks are obtained when cyclohexyl methacrylate is used as a monomer, preferably at not less than 70% by weight, based on the monomers employed.

The above monoethylenically unsaturated monomers are used together with polyethylenically unsaturated monomers. An alternative option is to use substantially exclusively polyethylenically unsaturated monomers.

The polyethylenically unsaturated monomers include compounds which have at least two nonconjugated, ethylenically unsaturated double bonds, examples being the diesters of dihydric alcohols with α,β-monoethylenically unsaturated C₃-C₁₀ monocarboxylic acids. Examples of compounds of this kind are alkylene glycol diacrylates and dimethacrylates, such as ethylene glycol diacrylate, 1,3-butylene glycol diacrylate, 1,4-butylene glycol diacrylate, propylene glycol diacrylate, and polyethylene glycol di(meth)acrylate, divinylbenzene, vinyl methacrylate, vinyl acrylate, allyl methacrylate, allyl acrylate, diallyl maleate, diallyl fumarate, methylenebisacrylamide, cyclopentadienyl acrylate, tricyclodecenyl (meth)acrylate, N,N′-divinylimidazolin-2-one or triallyl cyanurate.

The crosslinking monomers may additionally be, for example, epoxide or urethane (meth)acrylates.

Epoxide (meth)acrylates are, for example, those of the kind obtainable by reacting polyglycidyl or diglycidyl ethers, such as bisphenol A diglycidyl ether, with (meth)acrylic acid.

The reaction is known to the skilled worker and described, for example, in R. Holmann, U.V. and E.B. Curing Formulation for Printing Inks and Paints, London 1984.

Urethane (meth)acrylates are more particularly reaction products of hydroxyalkyl (meth)acrylates with polyisocyanates and/or diisocyanates (see likewise R. Holmann, U.V. and E.B. Curing Formulation for Printing Inks and Paints, London 1984).

The urethane (meth)acrylates also include the reaction products of hydroxyalkyl (meth)acrylates with isocyanurates. Preferred isocyanurates are those of the typical diisocyanates. Mention may be made more particularly of diisocyanates X(NCO)₂, wherein X is an aliphatic hydrocarbon radical having 4 to 15 carbon atoms, a cycloaliphatic or aromatic hydrocarbon radical having 6 to 15 carbon atoms or an araliphatic hydrocarbon radical having 7 to 15 carbon atoms. Examples of such diisocyanates are tetramethylene diisocyanate, hexamethylene diisocyanate, dodecamethylene diisocyanate, 1,4-diisocyanatocyclohexane, 1-isocyanato-3,5,5-trimethyl-5-isocyanatomethylcyclohexane (IPDI), 2,2-bis(4-isocyanatocyclohexyl)-propane, trimethylhexane diisocyanate, 1,4-diisocyanatobenzene, 2,4-diisocyanato-toluene, 2,6-diisocyanatotoluene, 4,4″-diisocyanatodiphenylmethane, 2,4″-diiso-cyanatodiphenylmethane, p-xylylene diisocyanate, tetramethylxylylene diisocyanate (TMXDI), the isomers of the bis(4-isocyanatocyclohexyl)methane (HMDI) such as the trans/trans, the cis/cis, and the cis/trans isomer, and mixtures of these compounds.

The crosslinking monomers are used typically in an amount of 0.1 to 100 mol %, e.g., 0.1 to 30 mol %, preferably 1 to 20 mol %, more particularly 3 to 10 mol %, based on the total amount of constituent monomers.

If appropriate it is also possible to use aftercrosslinking monomers as well. The crosslinking-active sites of the aftercrosslinking monomers do not take part in the molecular enlargement reaction, but may be selectively aftercrosslinked in a later step. Examples of suitable aftercrosslinking monomers include glycidyl methacrylate, acrylamidoglycolic acid, methyl methylacrylamidoglycolate, N-methylolacrylamide, N-methylolmethacrylamide, N-methylol allyl carbamate, alkyl ethers and esters of

N-methylolacrylamide and also of N-methylolmethacrylamide and of N-methylol allyl carbamate, and also acryloyloxypropyltri(alkoxy)silanes and methacryloyloxypropyltri-(alkoxy)silanes, vinyltrialkoxysilanes, and vinylmethyldialkoxysilanes.

The amount of the crosslinking monomers is chosen so as to give a desired degree of crosslinking. The degree of crosslinking is defined as the amount of substance (in mol) of crosslinkers divided by the amount of substance (in mol) of the total monomers present. The degree of crosslinking is preferably 1% to 20%, more particularly 3% to 10%.

The polymerization is initiated by means of a free-radical-forming initiator and/or by means of high-energy radiation such as UV radiation or electron beams. It is also possible to use redox initiator couples which comprise an oxidant and a reductant. The initiator is used typically in an amount of 0.1% to 2% by weight, based on the total amount of the monomers of the crosslinked polymer. Suitable initiators from the class of the peroxide compounds, azo compounds or azo peroxide compounds are known to the skilled worker and are available commercially.

Examples of suitable initiators that may be listed include di-tert-butyl oxypivalate, didecanoyl peroxide, dilauroyl peroxide, diacetyl peroxide, di-tert-butyl peroctoate, dibenzoyl peroxide, tert-butyl peracetate, tert-butyl peroxyisopropyl carbonate, tert-butyl perbenzoate, di-tert-butyl peroxide, 1,1-bis(tert-butylperoxy)-3,3,5-trimethyl-cyclohexane, 2,5-dimethyl-2,5-bis(benzoylperoxy)hexane, 1,4-di(tert-butylperoxy-carbonyl)cyclohexane, 1,1-bis(tert-butylperoxy)cyclohexane, di-tert-butyl diperoxy-azelate, or di-tert-butyl peroxycarbonate. Among these, dilauroyl peroxide, dibenzoyl peroxide, tert-butyl perbenzoate, and tert-butyl peroxyisopropyl carbonate are preferred.

An example of a suitable azo initiator is azoisobutyronitrile (AIBN).

In certain embodiments a photoinitiator is used.

The photoinitiator may comprise, for example, what are known as a splitters, in other words photoinitiators in which a chemical bond is split, forming 2 free radicals which initiate the further crosslinking or polymerization reactions.

Mention may be made, for example, of acylphosphine oxides (Lucirin® products from BASF), hydroxyalkylphenones (e.g., Irgacure® 184), benzoin derivatives, benzyl derivatives, and dialkyloxyacetophenones.

More particularly the photoinitiator may comprise what are known as H abstractors, which detach a hydrogen atom from the polymer chain; examples include photoinitiators with a carbonyl group. This carbonyl group is inserted into a C—H bond to form a C—C—O—H moiety.

Here mention may be made more particularly of acetophenone, benzophenone, and their derivatives.

It is possible to use both classes of photoinitiators alone or else in a mixture.

The thermal polymerization takes place typically at an elevated temperature, a suitable temperature range being from 40 to 180° C., preferably 60 to 120° C. With advantage it is also possible to increase the temperature in stages. Where the polymerization is initiated by high-energy radiation, lower temperatures are also suitable, ambient temperature for example.

The polymerization may take place in a variety of ways. Typically it takes place as a bulk polymerization, solution polymerization, emulsion polymerization or miniemulsion polymerization.

Solvents may be used as well if appropriate. In the case of low to medium fractions, as for example where the weight ratio of the first phase to the second phase is up to 70:30, the synthesis may take place in the absence of solvent if the isobutene polymer is soluble in the precursors of the crosslinked polymer, e.g., the constituent monomers. The monomers act as reactive solvents. To reduce the viscosity of the reaction mixture it may nevertheless be advantageous to use a solvent as well. At weight ratios of the first phase to the second phase of more than 70:30, or if the isobutene polymer is not soluble, or not sufficiently, in the precursors of the crosslinked polymer, the addition of a solvent is generally unavoidable.

Suitability for this purpose is possessed by saturated or unsaturated aliphatic hydrocarbons such as hexane, pentane, isopentane, cyclohexane, methylcyclohexane, diisobutene, triisobutene, tetraisobutene, pentaisobutene, hexaisobutene or mixtures thereof, aromatic hydrocarbons such as benzene, toluene, xylene, halogenated hydrocarbons, such as dichloromethane or trichloromethane, or mixtures thereof.

The polymerization can also be carried out in the presence of a plasticizer or a mixture of plasticizers, such as the phthalates and adipates of aliphatic or aromatic alcohols, examples being di(2-ethylhexyl) adipate, di(2-ethylhexyl) phthalate, diisononyl adipate or diisononyl phthalate.

Crosslinked Polysiloxane

Polysiloxanes are preparable by hydrolysis and condensation of silanes having hydrolyzable groups. Hydrolyzable groups are more particularly alkoxy groups (Si—OR) or halogen atoms (Si-Hal).

Precursors used for a crosslinked polysiloxane are preferably difunctional silanes, such as dimethoxydimethylsilane, diethoxydimethylsilane, dimethoxydiphenylsilane, diethoxydiphenylsilane, dimethyldichlorosilane, diphenyldichlorosilane and/or α,ω-dihydroxypolydimethylsiloxanes or α,ω-dihydroxypolydimethyldiphenylsiloxanes (preferably with a molar mass of 300 to 5000), together with silanes having three and/or silanes having four hydrolyzable groups, such as trimethoxymethylsilane, triethoxymethylsilane, trimethoxyphenylsilane, triethoxyphenylsilane; tetramethoxy-silane or tetraethoxysilane.

The relative amounts of the di-, tri- and/or tetrafunctional silanes are chosen so as to give a desired degree of crosslinking.

The silanols formed during the hydrolysis undergo condensation to form siloxane bonds.

As a catalyst it is possible to use tin compounds or titanium compounds, e.g., tin(II) octanoate.

Crosslinked Polyurethanes and/or Polyureas

Reaction of polyisocyanates with at least one isocyanate-reactive compound selected from polyols, polyamines or compounds having amine and hydroxyl functions produces polyurethanes and/or polyureas. To give networks, at least the polyisocyanate and/or the isocyanate-reactive compound must have an average functionality of more than 2.

Examples of suitable polyols include diols such as glycols, preferably glycols having 2 up to 25 carbon atoms, such as 1,2-ethanediol, 1,3-propanediol, 1,4-butanediol, 1,3-butanediol, 1,5-pentanediol, 1,4-pentanediol, 1,6-hexanediol, 1,10-decanediol, diethylene glycol, dihydroxymethylcyclohexane, bis(hydroxycyclohexyl)propane, tetramethylcyclobutanediol, cyclooctanediol or norbornanediol, etc. Suitable triols and polyols have for example 3 to 25, preferably 3 to 18, carbon atoms. They include, for example, glycerol, trimethylolpropane, erythritol, pentaerythritol, sorbitol, etc.

Also suitable as polyols are α,ω-hydroxy-terminated polymers, such as polyester diols, polycarbonate diols, polyetherols and α,ω-dihydroxyalkylpolysiloxanes, for example.

Suitable polyetherols are polyalkylene glycols, e.g., polyethylene glycols, polypropylene glycols, polytetrahydrofurans, etc., copolymers of ethylene oxide and propylene oxide or block copolymers of ethylene oxide, propylene oxide and/or butylene oxide, comprising the alkylene oxide units in copolymerized form in random distribution or in the form of blocks. Suitable compounds also include α,ω)-diamino polyethers, which are preparable by aminating polyalkylene oxides with ammonia.

Suitable polyester diols include all those which are typically used to prepare polyurethanes, more particularly those based on aromatic dicarboxylic acids, such as terephthalic acid, isophthalic acid, phthalic acid, Na or K sulfoisophthalic acid, etc., aliphatic dicarboxylic acids, such as adipic acid or succinic acid, etc., and cycloaliphatic dicarboxylic acids, such as 1,2-, 1,3- or 1,4-cyclohexanedicarboxylic acid. More particularly suitable as the diol component of the polyester diols are aliphatic diols, such as ethylene glycol, propylene glycol, 1,6-hexanediol, neopentyl glycol, diethylene glycol, polyethylene glycols, polypropylene glycols and 1,4-dimethylolcyclohexane.

Preference is given to polyester diols based on aromatic and aliphatic dicarboxylic acids and aliphatic diols, more particularly those in which the aromatic dicarboxylic acid accounts for 10 to 95 mol %, more particularly 40 to 90 mol %, of the overall dicarboxylic acid fraction (the remainder being aliphatic dicarboxylic acids).

Also suitable are polycarbonate diols. Polycarbonate diols come about, for example, through condensation of phosgene or carbonic esters such as diphenyl carbonate or dimethyl carbonate with dihydroxy compounds. Suitable dihydroxy compounds are aliphatic or aromatic dihydroxy compounds. Suitable aliphatic dihydroxy compounds are those specified above in the context of the polyester diols. Examples of aromatic dihydroxy compounds include bisphenols such as 2,2-bis(4-hydroxyphenyl)propane (bisphenol A), tetraalkylbisphenol A, 4,4-(meta-phenylenediisopropyl)diphenol (bisphenol M), 4,4-(para-phenylenediisopropyl)diphenol, 1,1-bis(4-hydroxyphenyI)-3,3,5-trimethylcyclohexane (BP-TMC), 2,2-bis(4-hydroxyphenyl)-2-phenylethane, 1,1-bis(4-hydroxyphenyl)cyclohexane (bisphenol Z), and also, if appropriate, their mixtures. The polycarbonates may be branched as a result of small amounts of branching agents. The suitable branching agents include phloroglucinol, 4,6-dimethy1-2,4,6-tri(4-hydroxyphenyl)hept-2-ene, 4,6-dimethyl-2,4,6-tri(4-hydroxyphenyl)heptane; 1,3,5-tri(4-hydroxyphenyl)benzene; 1,1,1-tri(4-hydroxyphenyl)heptane; 1,3,5-tri(4-hydroxyphenyl)benzene; 1,1,1-tri(4-hydroxyphenyl)ethane; tri(4-hydroxyphenyl)phenylmethane, 2,2-bis[4,4-bis(4-hydroxyphenyl)cyclohexyl]-propane; 2,4-bis(4-hydroxyphenylisopropyl)phenol; 2,6-bis(2-hydroxy-5′-methylbenzyl)-4-methylphenol; 2-(4-hydroxyphenyI)-2-(2,4-dihydroxyphenyl)propane; hexa(4-(4-hydroxyphenylisopropyl)phenyl)-ortho-terephthalic acid ester; tetra(4-hydroxyphenyl)-methane; tetra(4-(4-hydroxyphenylisopropyl)phenoxy)methane; a,a′,a″-tris(4-hydroxy-phenyl)-1,3,5-triisopropylbenzene; 2,4-dihydroxybenzoic acid; trimesic acid; cyanuric chloride; 3,3-bis(3-methyl-4-hydroxypheny1)-2-oxo-2,3-dihydroindole, 1,4-bis(4′,4″-di-hydroxytriphenyl)methyl)benzene, and more particularly 1,1,1-tri(4-hydroxyphenyl)-ethane and bis(3-methyl-4-hydroxypheny1)-2-oxo-2,3-dihydroindole.

Suitable polysiloxanes a) are, for example, α,ω-dihydroxyalkylpolydimethylsiloxanes.

Suitable polyamines are, for example, ethylenediamine, hexamethylenediamine, and diethylenetriamine.

Suitable compounds having amine and hydroxyl functions are, for example, ethanolamine, n-propanolamine, n-butanolamine, pentanolamine, hexanolamine, heptanolamine or octanolamine.

The polyisocyanate is an isocyanate with a functionality of two or more selected preferably from diisocyanates, the biurets and cyanurates of diisocyanates, and the adducts of diisocyanates with polyols. Suitable diisocyanates generally have 4 to 22 C atoms. The diisocyanates are typically selected from aliphatic, cycloaliphatic, and aromatic diisocyanates, examples being 1,4-diisocyanatobutane, 1,6-diisocyanato-hexane, 1,6-diisocyanato-2,2,4-trimethylhexane, 1,6-diisocyanato-2,4,4-trimethyl-hexane, 1,2-, 1,3-, and 1,4-diisocyanatocyclohexane, 2,4- and 2,6-diisocyanato-1-methylcyclohexane, 4,4′-bis(isocyanatocyclohexyl)methane, isophorone diisocyanate (=1-isocyanato-3,3,5-trimethyl-5-isocyanatomethylcyclohexane), tolylene 2,4- and 2,6-diisocyanate, tetramethylene-p-xylylene diisocyanate (=1,4-bis(2-isocyanatoprop-2-yl)benzene), 4,4′-diisocyanatodiphenylmethane, preferably 1,6-diisocyanatohexane and isophorone diisocyanate, and mixtures thereof. Preferred compounds comprise the cyanurates and biurets of aliphatic diisocyanates, more particularly the cyanurates. Particularly preferred compounds are the isocyanurate and the biuret of isophorone diisocyanate, and the isocyanurate and the biuret of 1,6-diisocyanatohexane.

Examples of adducts of diisocyanates with polyols are the adducts of the abovementioned diisocyanates with glycerol, trimethylolethane, and trimethylol-propane, an example being the adduct of tolylene diisocyanates with trimethylolpropane, or the adducts of 1,6-diisocyanatohexane or isophorone diisocyanate with trimethylolpropane and/or glycerol.

To accelerate the reaction between the isocyanate-reactive groups of the isobutene polymer and the isocyanate groups of the crosslinking agent it is possible to use known catalysts, such as dibutyltin dilaurate, tin(II) octoate, 1,4-diazabicyclo[2.2.2]octane or amines, such as triethylamine. These catalysts are used typically in an amount of 10⁻⁵ to 10⁻² g, based on the weight of the crosslinking agent.

The crosslinking density can be controlled by varying the functionality of the polyisocyanate, the molar ratio of the polyisocyanate to the hydroxyl-terminated isobutene polymer, or through accompanying use of monofunctional compounds that are reactive toward isocyanate groups, such as monohydric alcohols, ethylhexanol or propylheptanol for example.

Resole Resins

Resole resins are prepared by condensing a phenol component and an aldehyde component. Their preparation has long been known and is described for example in A. Garziella, L. A. Pilato, A. Knop, Phenolic Resins; Springer Verlag (2000).

Besides phenol, which is particularly preferred, suitable phenol compounds also include substituted phenols such as, for example, cresols or nonylphenol, or phenolic compounds, such as bisphenol A, for example, in each case if appropriate in combination with phenol.

Examples of suitable aldehydes are formaldehyde, butyraldehyde or glyoxal. Particularly preferred is formaldehyde.

The resole resins are prepared by condensing the phenol component and the aldehyde in the presence of a basic catalyst, such as ammonium hydroxide or an alkali metal hydroxide. It is preferred to use alkali metal hydroxide catalysts such as sodium hydroxide and potassium hydroxide. The molar ratio of aldehyde (given as formaldehyde) to phenol in the resole resin can vary in the range from 1:1 to 3:1, but is preferably in the range from 1.6:1 to 2.5:1. Here, by electrophilic substitution, three hydrogen atoms of the phenol molecule are replaced by one —CH₂—OH group in each case. Through elimination of water, these polyfunctional phenol derivatives undergo condensation to form precondensates.

Suitable precondensates, which may also be modified, alkylated for example, more particularly methylated or butylated, are then condensed with acidic condensing agents to give crosslinked systems of high molecular mass.

An example of a procedure for producing the network of the invention is to dissolve or disperse the isobutene polymer in the precursors of the crosslinked polymer, the constituent monomers for example, if appropriate with addition of a solvent, to introduce the solution or dispersion into a casting mold, and to initiate the molecular enlargement reaction, by means of a temperature increase or high-energy radiation, for example. After the network has formed the material can be demolded.

An alternative procedure is to convert the solution or dispersion into a plastic state by adding fillers and/or thickeners. The plastic composition can then be shaped into any desired form. Shaping may take place advantageously by extrusion through a shaping die. In this way it is easy to produce sealing profiles, for example. The form of the shaped composition is then fixed by initiation of the crosslinking molecular enlargement reaction.

Alternatively it is possible to prepare a solution or dispersion and to initiate the molecular enlargement reaction, the degree of crosslinking being set such that the network obtained primarily is still shapeable. The network obtained primarily can then be shaped, if appropriate following addition of fillers, into any desired form. The form of the shaped composition is then fixed by aftercrosslinking. The aftercrosslinking can be achieved by temperature increase, high-energy radiation and/or suitable catalysts or the like. Aftercrosslinking is made easier if, in the molecular enlargement reaction, the monomers used include aftercrosslinking monomers, whose crosslinking-active sites do not take part in the molecular enlargement reaction and can be selectively aftercrosslinked after the molecular enlargement reaction and shaping.

The compositions of the invention may further comprise typical auxiliaries which are typical for the application in question. These include, for example, fillers, diluents or stabilizers.

In preferred embodiments active or effect substances are incorporated into the semi-interpenetrating networks of the invention. Suitable active substances are biocides, for example; suitable effect substances are dyes. The active or effect substances are generally not miscible with pure polyisobutene, but are soluble or dispersible in the semi-interpenetrating network or can be anchored covalently in the crosslinked polymer. The invention therefore for the first time shows a way of combining the properties of isobutene polymers with the properties of the active and effect substances.

Examples of suitable fillers include silica, including colloidal silica, calcium carbonate, carbon black, titanium dioxide, mica, quartz, glass fibers and glass beads, and the like.

Examples of suitable diluents include polybutene, liquid polybutadiene, hydrogenated polybutadiene, liquid paraffin, naphthenates, atactic polypropylene, dialkyl phthalates, reactive diluents, e.g., alcohols, and oligoisobutenes.

Examples of suitable stabilizers include 2-benzothiazolyl sulfide, benzothiazole, thiazole, dimethyl acetylenedicarboxylate, diethyl acetylenedicarboxylate, butylated hydroxytoluene (BHT), butylated hydroxyanisole, and vitamin E.

The invention also provides a method of forming an adhesive bond between substrates, sealing cavities in or between substrates, or embedding substrates, wherein a composition is introduced between the substrates to be bonded or into the cavities to be sealed, such as joints between identical or different substrates, for example, or the substrate to be embedded is surrounded with a composition, which comprises a linear noncrosslinked isobutene polymer and polyfunctional resin precursors and/or monomers together with at least one crosslinking agent (this composition also being referred to below as “noncrosslinked semi-IPN”), and in the composition a molecular enlargement reaction is initiated.

In preferred embodiments the composition comprises a linear noncrosslinked isobutene polymer and ethylenically unsaturated monomers comprising at least one polyethylenically unsaturated monomer. For the molecular enlargement reaction a free-radical polymerization is initiated in the composition.

The free-radical polymerization is initiated preferably thermally or by high-energy radiation, more particularly by UV light. In the case of initiation by high-energy radiation the composition preferably comprises at least one photoinitiator.

The consistency of the composition can be tailored to the specific end use by addition of suitable auxiliaries, such as fillers, thickeners and/or rheology modifiers.

The method is especially suitable if at least one of the substrates is selected from glass, ceramic materials, such as flags or tiles, in the sanitary segment for example, and mineral building materials, such as cement, mortar, concrete or shaped mineral pieces, bricks for example. In another embodiment the substrate is selected from electronic components.

The invention also provides a method of producing substantially two-dimensional structures, more particularly films, wherein a composition which comprises a linear noncrosslinked isobutene polymer and polyfunctional resin precursors and/or monomers together with at least one crosslinking agent is applied to a support and in the composition a molecular enlargement reaction is initiated.

In preferred embodiments the composition comprises a linear noncrosslinked isobutene polymer and ethylenically unsaturated monomers comprising at least one polyethylenically unsaturated monomer. For the molecular enlargement reaction a free-radical polymerization is initiated in the composition.

The free-radical polymerization is initiated preferably thermally or by high-energy radiation, more particularly by UV light. In the case of initiation by high-energy radiation the composition preferably comprises at least one photoinitiator. The coated support is irradiated with high-energy light, preferably UV light, in order to achieve the desired crosslinking. The radiation energy may amount, for example, to 10 mJ/cm² to 1500 mJ/cm² of irradiated area.

The support material may be a temporary support, from which the substantially two-dimensional structure is removed again following production or immediately prior to use, such as a roller, a release sheet of paper, which may have been siliconized, or a polymeric film, comprising polyolefins or PVC, for example.

Application to the support may take place by known techniques, such as by roller application, knifecoating, dipping or the like, for example. The amount applied may in particular be 10 to 300 g, preferably 10 to 150 g, and typically often 20 to 80 g per square meter of support.

The materials of the invention are suitable for the applications below. Depending on the end application, preformed semi-interpenetrating networks (in the form, for example, of sheets) are employed or the semi-interpenetrating network is obtained in situ from a noncrosslinked semi IPN:
Sealants for windows or doors. The semi-interpenetrating network of the invention can be used at higher temperatures than pure PIB in the window sealing segment without any exudation occurring.
Sealing material for the sanitary segment. The noncrosslinked semi IPN is introduced and polymerized/crosslinked in situ, in order to produce watertight sealants adhering well to building materials. The sealants inhibit infestation by fungi or bacteria. Compositions of this kind could be used to replace moisture- crosslinking silicone systems.
Antifouling coatings, which reduce or prevent colonization by microorganisms, such as bacteria or algae.
Watertight sheeting, for lining boreholes and cavities in geological formations into which combustion residues, for example, are placed, for example.
Materials or moldings for the roofing of buildings, in the form of sheet webs or panels.
Polymer films for glass coating. Films of the semi-interpenetrating network of the invention can be adhered flatly to glass surfaces, more particularly panes of glass. These films serve for protection from radiation or impart color to the pane of glass (autoglass tinting).
Ultrathin films which are applied for the purpose of protection from moss, algae or mold to articles such as sculptures, paintings, old books or monuments.
Adhesives with high tack at the contact faces and high cohesion internally. It is supposed that there is a certain phase separation, with the consequence that isobutene polymer emerges on the outer surfaces. The isobutene polymer penetrates the microscopic surface unevennesses and cavities of the surfaces to be bonded. This ensures effective wetting of the surfaces and adhesion. Within the adhesive, the network brings about structural integrity and hence high cohesion of the composition. The adhesives can be formulated so as to be transparent. They exhibit advantages over dispersion-based adhesives, which can become cloudy on contact with water.
Adhesives for hydrophobic surfaces, such as plastics.
Adhesives for glass surfaces, examples being double glazing adhesives/safety glass. Safety glass is constructed from a glass/polymer sheet/glass sandwich setup. The sheet used is conventionally polyvinyl butyral. The adhesive properties and the mechanical reinforcement can also be achieved with sheets of semi-interpenetrating networks of the invention.
Adhesives for what are called 100% systems, where the curing of the adhesive is accomplished, following application, by later crosslinking.
Insulator layers for the electronics industry. Semi-interpenetrating networks of the invention permit the use of PIB in the electronics industry for the watertight sealing/packaging of electronic components, in order to prevent short circuits, corrosion, etc.

This enumeration of the potential applications is not conclusive.

The invention is illustrated in more detail by the attached figures and the examples which follow (polyisobutene is occasionally abbreviated below to PIB).

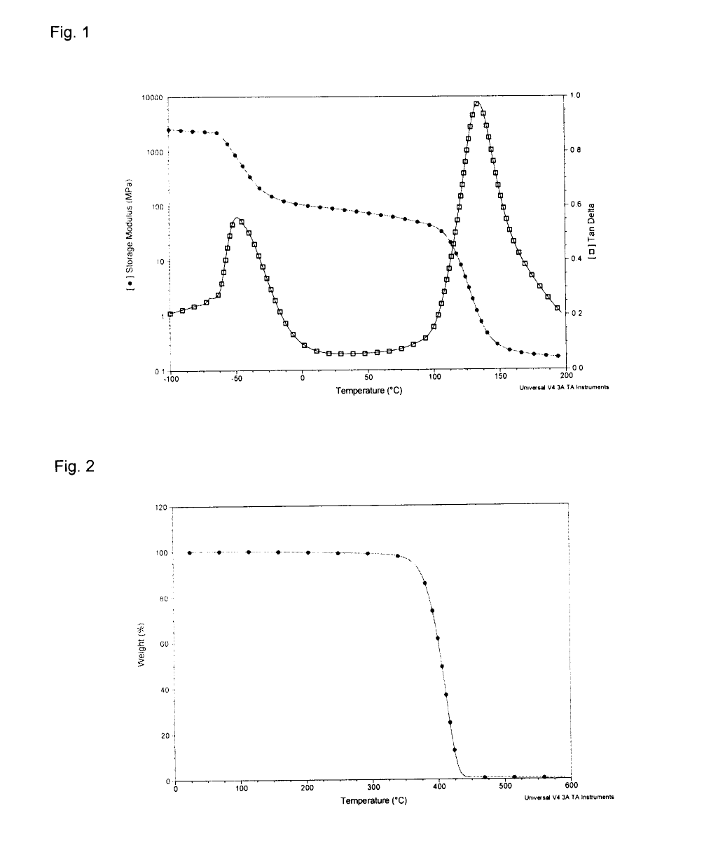

FIG. 1 shows the storage modulus (circles) and the loss factor (tan δ) (squares) as a function of the temperature for a semi-interpenetrating network (semi IPN) of polyisobutene/polystyrene (weight ratio 50/50).

FIG. 2 shows the change in the mass of the sample as a function of temperature for a semi IPN of polyisobutene/polystyrene (weight ratio 50/50).

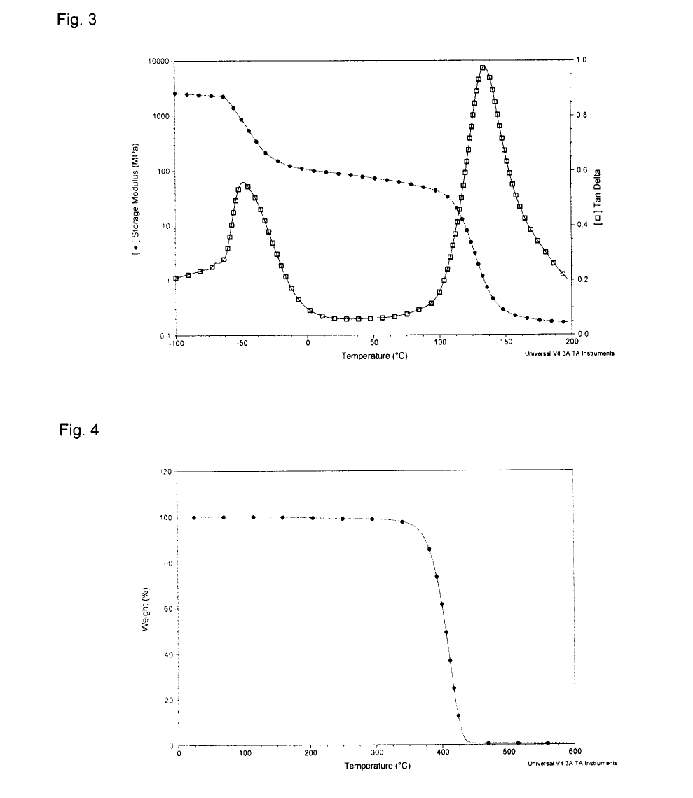

FIG. 3 shows the storage modulus (circles) and the loss factor (tan δ) (squares) as a function of the temperature for a semi-interpenetrating network (semi IPN) of polyisobutene/polystyrene (weight ratio 60/40).

FIG. 4 shows the change in the mass of the sample as a function of temperature for a semi IPN of polyisobutene/polystyrene (weight ratio 60/40).

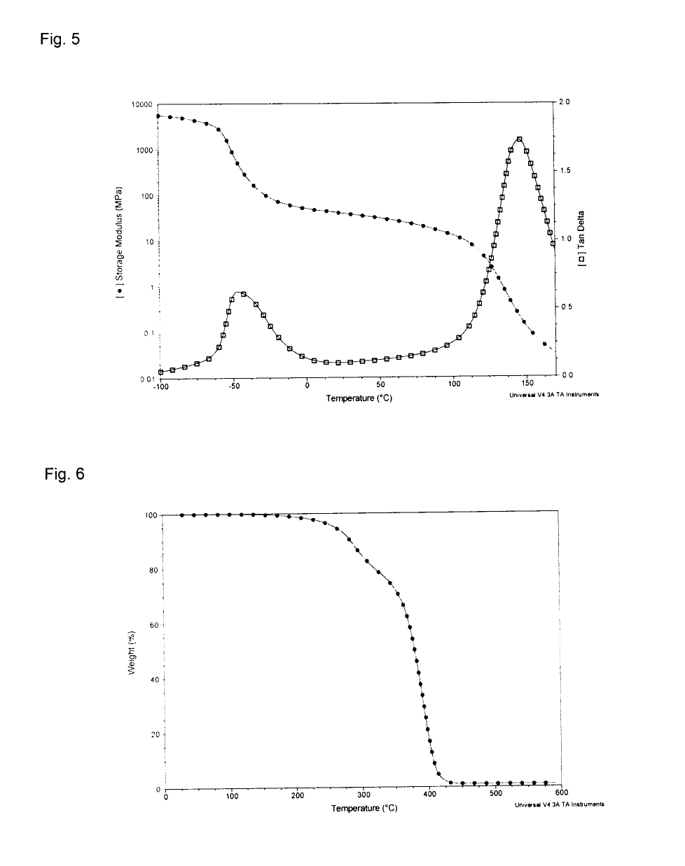

FIG. 5 shows the storage modulus (circles) and the loss factor (tan δ) (squares) as a function of the temperature for a semi-interpenetrating network (semi IPN) of polyisobutene/polycyclohexyl methacrylates (weight ratio 70/30).

FIG. 6 shows the change in the mass of the sample as a function of temperature for a semi IPN of polyisobutene/polycyclohexyl methacrylates (weight ratio 70/30).

### EXAMPLE 1

Preparation in the Absence of a Solvent

With stirring, 2 g of Oppanol® B 15 SFN (molar mass Mn 75 000) were dissolved in 2 g of styrene and 0.2 g of divinylbenzene. The mixture was admixed with 0.04 g of benzoyl peroxide and mixed thoroughly. When a homogeneous, viscose solution had been obtained, the solution was transferred to a casting mold, which was composed of two glass plates held apart by a Teflon seal having a thickness of 1 mm. The casting mold was held together with brackets and placed in an oven with temperature control. The temperature was held at 80° C. for 5 hours. The casting mold was removed from the oven and left to cool and the sample was demolded.

This gave a white material. The thermomechanical properties (measured using a dynamic thermomechanical analysis instrument DMTA) of the resulting semi-interpenetrating network are shown in FIG. 1. The resulting semi-interpenetrating network, with a weight ratio of PIB/polystyrene phase of 50/50, shows two mechanical relaxations at −50 and 150° C., which are characteristic of PIB and polystyrene respectively. This is an indication of the presence of discrete polymer phases which are not chemically bonded to one another. The resulting semi-interpenetrating network shows a storage modulus of 250 MPa at 20° C. and no cold flow at high temperatures (up to 200° C.).

Thermogravimetric analysis (TGA) shows a considerable loss of mass at temperatures above 350° C., which illustrates the breakdown of the material (see FIG. 2). There is no separation preceding this.

### EXAMPLE 2

Preparation in the Presence of a Solvent

To lower the viscosity of the initial mixture, the semi-interpenetrating network can also be prepared in the presence of a solvent.

With stirring, 3 g of Oppanol® B 15SFN and 0.04 g of benzoyl peroxide were dissolved in 2 g of styrene, 0.1 g of divinylbenzene, and 0.8 ml of toluene. When a homogeneous, viscose solution had been obtained, the solution was transferred to a casting mold, which was composed of two glass plates held apart by a Teflon seal having a thickness of 1 mm. The casting mold was held together with brackets and placed in an oven with temperature control. The temperature was held at 80° C. for 5 hours. The casting mold was removed from the oven and left to cool and the sample was demolded.

This gave a white material. The resulting semi-interpenetrating network, with a weight ratio of PIB/polystyrene phase of 60/40, shows two mechanical relaxations at −50 and 140° C. (see FIG. 3) and a storage modulus of approximately 100 MPa at room temperature. At high temperatures (up to 200° C.) no cold flow is found.

According to TGA, carried out under argon, damage to the semi-interpenetrating network was found at temperatures above 375° C. (see FIG. 4).

### EXAMPLE 3

Preparation in the Absence of a Solvent

A reaction vessel was charged with 2 g of Oppanol® B 15 SFN, 2 g of cyclohexyl methacrylate, and 0.1 g of ethylene glycol dimethacrylate (5% by weight, based on cyclohexyl methacrylate). The mixture was stirred cautiously under an argon atmosphere. Thereafter 0.04 g of benzoyl peroxide (2% by weight, based on cyclohexyl methacrylate) was added. The mixture was stirred and thereafter placed into a casting mold. The casting mold was placed in an oven. The temperature was held at 70° C. for 6 hours. The casting mold was removed from the oven and left to cool and the sample was demolded. This gave a transparent material.

### EXAMPLE 4

Preparation in the Presence of a Solvent

A reaction vessel was charged with 3 g of Oppanol® B15SFN, 1.3 g of cyclohexyl methacrylate, 64 mg of ethylene glycol dimethacrylate (5% by weight, based on cyclohexyl methacrylate), and 2.7 ml of toluene. The mixture was stirred cautiously under an argon atmosphere. Thereafter 26 mg of benzoyl peroxide (2% by weight, based on cyclohexyl methacrylate) were added. The mixture was stirred and thereafter placed into a casting mold. The casting mold was placed in an oven. The temperature was held at 80° C. for 5 hours. The casting mold was removed from the oven and left to cool and the sample was demolded. This gave a transparent material.

The resulting semi-interpenetrating network, with a weight ratio of PIB/polycyclohexyl methacrylate phase of 70/30, shows two mechanical relaxations at −45 and 145° C., which are characteristic of the PIB and polycyclohexyl methacrylate phases, respectively, and a storage modulus of 40 MPa at room temperature (see FIG. 5).

According to the TGA, which was carried out under an argon atmosphere, a loss of mass was found above 250° C., which presumably can be attributed to escape of toluene.

### EXAMPLE 5

Preparation in the Absence of a Solvent

In a way similar to that described in example 3, a semi-interpenetrating network was produced with a 60/40 weight ratio of PIB/polycyclohexyl methacrylate phase.

### EXAMPLE 6

General Instructions for Preparing Semi-Interpenetrating Networks with PIB/Polyalkyl Methacrylate Phase in the Absence of a Solvent

Oppanol® B15SFN, C3-C18 alkyl methacrylate, and crosslinker were charged to a 100 ml reaction vessel with a mechanical stirrer. The mixture was carefully stirred until homogeneous. Then a free-radical initiator was added. The mixture was stirred for half an hour more and then introduced into a casting mold, which was composed of two glass plates held apart by a Teflon seal having a thickness of 1 mm in order to give the sample in the form of a film. The casting mold was held together with brackets and placed in an oven with temperature control. The temperature was held at the stated temperature (according to the free-radical initiator chosen) for the specified time period. The casting mold was removed from the oven and cooled and the sample was demolded.

### EXAMPLE 7

2 g of Oppanol® B15SFN, 2 g of butyl methacrylate, and 0.1 g of ethylene glycol dimethacrylate (5% by weight, based on butyl methacrylate) were introduced as an initial charge. The mixture was carefully stirred under argon. Thereafter 0.04 g of benzoyl peroxide (2% by weight, based on butyl methacrylate) was added. The mixture was stirred and then introduced into a casting mold. The casting mold was placed in an oven. The temperature was held at 70° C. for 6 hours. The casting mold was removed from the oven and cooled and the sample was demolded.

This gave a translucent material which contained 46% by weight of extractable mass (measured by Soxhlet extraction with dichloromethane over 48 h). The extractable mass consisted mainly of Oppanol® B15SFN.

### EXAMPLE 8

2 g of Oppanol® B15SFN, 2 g of hexyl methacrylate, and 0.1 g of ethylene glycol dimethacrylate (5% by weight, based on hexyl methacrylate) were introduced as an initial charge. The mixture was carefully stirred under argon. Thereafter 0.04 g of benzoyl peroxide (2% by weight, based on hexyl methacrylate) was added. The mixture was stirred and then introduced into a casting mold. The casting mold was placed in an oven. The temperature was held at 70° C. for 6 hours. The casting mold was removed from the oven and cooled and the sample was demolded.

This gave a white material which contained 53% by weight of extractable mass (measured by Soxhlet extraction with dichloromethane over 48 h). The extractable mass consisted mainly of Oppanol® B15SFN.

### EXAMPLE 9

2 g of Oppanol® B15SFN, 2 g of isobutyl methacrylate, and 0.1 g of ethylene glycol dimethacrylate (5% by weight, based on isobutyl methacrylate) were introduced as an initial charge. The mixture was carefully stirred under argon. Thereafter 0.04 g of benzoyl peroxide (2% by weight, based on isobutyl methacrylate) was added. The mixture was stirred and then introduced into a casting mold. The casting mold was placed in an oven. The temperature was held at 70° C. for 6 hours. The casting mold was removed from the oven and cooled and the sample was demolded. This gave a white material.

### EXAMPLE 10

2 g of Oppanol® B15SFN, 2 g of tert-butyl methacrylate, and 0.1 g of ethylene glycol dimethacrylate (5% by weight, based on tert-butyl methacrylate) were introduced as an initial charge. The mixture was carefully stirred under argon. Thereafter 0.04 g of benzoyl peroxide (2% by weight, based on tert-butyl methacrylate) was added. The mixture was stirred and then introduced into a casting mold. The casting mold was placed in an oven. The temperature was held at 70° C. for 6 hours. The casting mold was removed from the oven and cooled and the sample was demolded. This gave a white material.

### EXAMPLE 11

2 g of Oppanol® B15SFN, 2 g of isodecyl methacrylate, and 0.1 g of ethylene glycol dimethacrylate (5% by weight, based on isodecyl methacrylate) were introduced as an initial charge. The mixture was carefully stirred under argon. Thereafter 0.04 g of benzoyl peroxide (2% by weight, based on isodecyl methacrylate) was added. The mixture was stirred and then introduced into a casting mold. The casting mold was placed in an oven. The temperature was held at 70° C. for 6 hours. The casting mold was removed from the oven and cooled and the sample was demolded. This gave a white material which contained 46% by weight of extractable mass (measured by Soxhlet extraction with dichloromethane over 48 h). The extractable mass consisted mainly of Oppanol® B15SFN.

### EXAMPLE 12

2 g of Oppanol® B15SFN, 2 g of lauryl methacrylate, and 0.1 g of ethylene glycol dimethacrylate (5% by weight, based on lauryl methacrylate) were introduced as an initial charge. The mixture was carefully stirred under argon. Thereafter 0.04 g of benzoyl peroxide (2% by weight, based on lauryl methacrylate) was added. The mixture was stirred and then introduced into a casting mold. The casting mold was placed in an oven. The temperature was held at 70° C. for 6 hours. The casting mold was removed from the oven and cooled and the sample was demolded. This gave a white material.

### EXAMPLE 13

2 g of Oppanol® B15SFN, 2 g of stearyl methacrylate, and 0.1 g of ethylene glycol dimethacrylate (5% by weight, based on stearyl methacrylate) were introduced as an initial charge. The mixture was carefully stirred under argon. Thereafter 0.04 g of benzoyl peroxide (2% by weight, based on stearyl methacrylate) was added. The mixture was stirred and then introduced into a casting mold. The casting mold was placed in an oven. The temperature was held at 70° C. for 6 hours. The casting mold was removed from the oven and cooled and the sample was demolded. This gave a white material.

### EXAMPLE 14

A semi-interpenetrating network was prepared which had a weight ratio of PIB/polybutyl methacrylate phase of 50/50, in accordance with the instructions described in example 7, but with the addition of 8.6 mg of tetrachlorinated perylene to the initial mixture. This gave an orange material.

1. A semi-interpenetrating network having a first phase of a linear noncrosslinked isobutene polymer and a second phase of a crosslinked polymer, wherein the crosslinked polymer is obtained by crosslinking molecular enlargement reaction in the presence of the isobutene polymer.

2. The network according to claim 1, wherein the crosslinked polymer is obtained by free-radical polymerization of ethylenically unsaturated monomers comprising at least one polyethylenically unsaturated monomer.

3. The network according to claim 2, wherein the ethylenically unsaturated monomers comprise at least one of (meth)acrylic monomers and vinylaromatic monomers.

4. The network according to claim 3, wherein the ethylenically unsaturated monomers are selected from the group consisting of styrene, cyclohexyl methacrylate, and C3-C18 alkyl methacrylates.

5. The network according to claim 2, wherein the ethylenically unsaturated monomers essentially consist of polyethylenically unsaturated monomers.

6. The network according to claim 2, wherein the ethylenicably unsaturated monomers produce a polymer having a solubility parameter which differs from the solubility parameter of the isobutene polymer by less than 1 MPa^{1/2}.

7. The network according to claim 2, wherein the degree of crosslinking of the crosslinked polymer is 1% to 20%.

8. The network according to claim 1, wherein the crosslinked polymer is a polysiloxane.

9. The network according to claim 1, wherein the crosslinked polymer is at least one of polyurethane and polyurea.

10. The network according to claim 1, wherein the crosslinked polymer is a resole resin.

11. The network according to claim 1, wherein the weight ratio of the first phase to the second phase is 5:95 to 95:5.

12. The network according to claim 1, wherein the isobutene polymer has a number-average molecular weight of 500 to 500 000.

13. The network according to claim 1, having a weight ratio of the first phase to the second phase of 60:40 to 10:90,

14. The network according to claim 1, having a weight ratio of the first phase to the second phase of 60:40 to 90:10.

15. A process for preparing a semi-interpenetrating network according to claim 1, comprising subjecting polyfunctional resin precursors to a molecular enlargement reaction in the presence of the isobutene polymer.

16. A process for preparing a semi-interpenetrating network according to claim 1, comprising subjecting monomers which construct the crosslinked polymer, to a molecular enlargement reaction with at least one crosslinking agent in the presence of the isobutene polymer.

17. The process according to claim 15, comprising shaping the network obtained to a desired form and subjecting the formed composition to after-crosslinking.

18. A molding comprising a semi-interpenetrating network according to claim 1.

19. A method of forming an adhesive bond between substrates, sealing cavities in or between substrates, or embedding substrates, comprising introducing a composition between the substrates to be bonded or into the cavities to be sealed, or surrounding the substrate to be embedded with the composition, wherein the composition comprises a linear noncrosslinked isobutene polymer and polyfunctional resin precursors and/or monomers together with at least one crosslinking agent, and in the composition a molecular enlargement reaction is initiated.

20. The method according to claim 19, wherein the composition comprises a linear noncrosslinked isobutene polymer and ethylenically unsaturated monomers comprising at least one polyethylenically unsaturated monomer, and a free-radical polymerization is initiated in the composition.

21. The method according to claim 20, wherein the free-radical polymerization is initiated thermally or by high-energy radiation.

22. The method according to claim 20, wherein at least one substrate is selected from the group consisting of glass, ceramic materials, and mineral building materials.

23. A method of producing substantially two-dimensional structures, wherein a composition which comprises a linear noncrosslinked isobutene polymer and polyfunctional resin precursors and/or monomers together with at least one crosslinking agent is applied to a support and in the composition a molecular enlargement reaction is initiated.
